(19) United States
(12) Patent Application Publication
(10) Pub. No.: US 2010/0256899 A1
(43) Pub. Date: Oct. 7, 2010

(54) METHOD FOR OPERATING A NAVIGATION SYSTEM

(75) Inventor: Jochen Katzer, Bergtshofen (DE)

Correspondence Address: QUARLES & BRADY LLP, 411 E. WISCONSIN AVENUE, SUITE 2040, MILWAUKEE, WI, 53202-4497, US

(73) Assignee: NAVIGON AG, Hamburg (DE)

(21) Appl. No.: 12/740,025

(22) PCT Filed: Sep. 10, 2008
(86) PCT No.: PCT/DE2008/001502

§ 371 Date: Jun. 17, 2010

(30) Foreign Application Priority Data
Oct. 31, 2007 (DE) 10 2007 052 297.7

(51) Int. Cl. G01C 21/36

(52) U.S. Cl. 701/201

(57) ABSTRACT

The present invention relates to a method, wherein maneuvering instructions are output (09) for the user of a navigation system (10). For the schematic graphical illustration of a maneuvering instruction at an intersection, the position geometry of the road segments and junctions associated with the intersection is analyzed and a schematic maneuvering view (11) is calculated. In order to illustrate the intersection, predefined illustration elements (01-08) are loaded from a database as a function of the result of the analysis, and/or illustration elements (α) that are individually dependent on the position geometry are calculated.

The present invention relates to a method for operating a navigation system according to the preamble of claim 1.

Generic navigation systems are employed for instance as mobile navigation devices to navigate the driver of a motor vehicle from a starting position to a destination. In this process, the navigation device retrieves the data from a database in which a geographical territory is specified by road segments and junctions. Consequently, the database contains a network of road segments and interposed junctions specifying the route network, in particular the road network, in a machine-readable form, thusly making it possible to perform a processing operation in a data processing device with the aid of corresponding calculation algorithms.

With the aid of a suitable route calculation method, a route in the form of a sequence of road segments and junctions is selected on the basis of said data from the database to navigate the user from the starting position to the destination.

However, known navigation systems not only calculate the route from the starting position to the destination. In addition, the navigation systems likewise calculate maneuvering instructions which contain instructions for the user to execute maneuvers starting from the current position, said maneuvers prompting the user to follow the route. If the user for instance reaches an intersection, a maneuvering instruction is calculated indicating to the user the direction in which he/she is supposed to take a turn at the intersection.

For the output of the maneuvering instructions to the user, various to options are available. Typically, the maneuvering instruction is acoustically output in the form of a voice announcement. In a turning maneuver at an intersection, for instance the following announcement can be output: “Please turn left at the next intersection”. However, said acoustically output maneuvering instructions are afflicted with the drawback that they are not constantly available any more for the user subsequent to the output of the announcement. If the user has not caught the acoustic maneuvering instruction, the maneuvering instruction either needs to be repeated or else the user needs to continue the maneuvering process in the absence of maneuvering instructions. In order to solve this problem, in the known navigation systems so-called schematic maneuvering views are known. In said schematic maneuvering views, at least the maneuver to be executed next and/or the maneuver to be executed subsequent to the next maneuver is graphically illustrated in a schematized form and said graphical illustration is permanently displayed in a display device until the corresponding maneuver is executed. If the user reaches an intersection, said intersection is illustrated in the schematic maneuvering view in a schematized manner in the form of a graphical illustration.

In known navigation systems, static and dynamic schematic maneuvering views are distinguished. In the static schematic maneuvering views, predefined illustration elements stored in a database are loaded and the next maneuver is displayed by one of said predefined illustration elements. In other words, this means that for illustrating the schematic maneuvering view, predefined images are loaded from the database and are displayed. In particular at intersections with several road segments converging at one junction, said static illustration frequently proves to be insufficient to properly inform the driver of the maneuver to be executed next, since the illustration elements prestored in the database as a matter of fact only feature limited compliance with the real intersection situation. The larger the differences between the real intersection situation and the prestored image for illustrating said intersection situation, the worse the orientation of the driver.

Alternatively to the static illustration of the intersections with the aid of predefined illustration elements it is also known that the position geometry of the intersection is individually analyzed in a calculation unit, and on the basis thereof individual illustration elements for illustrating the individual intersections are calculated. However, for specific intersection types this approach, in turn, is disadvantageous, since the actual positional relations are unsuitable for unambiguously informing the user of the maneuver to be executed. If a road at an intersection for instance bifurcates into two branches and if the angle between the two branches is very small, the illustration of said very small real angle in the schematic maneuvering illustration thusly leads to the situation that merely two almost stacked lines are displayed. Such dynamic schematic maneuvering views hence fail to provide the user with unambiguous orientation.

Starting from this state of the art, consequently it is an object of the present invention to suggest a novel method for operating a navigation system which enhances the illustration of schematic maneuvering views.

Advantageous embodiments of the invention are the subject-matter of the dependent claims.

The inventive method is based on the fundamental idea that the static illustration with predefined illustration elements and the dynamic illustration with individually calculated illustration elements are each particularly beneficial for specific intersection types. Certain intersection types can be more accurately displayed in the schematic maneuvering view using static illustration forms, whereas other intersection types can be more accurately displayed in the schematic maneuvering view using dynamic illustration forms. In order to allow for this circumstance, according to the inventive method provision is made for the aspect that in the calculation of the schematic maneuvering view, initially the position geometry of the road segments and junctions associated with the intersection to be illustrated in the schematic maneuvering view is analyzed.

As a function of the result of said analysis, subsequently at least two different intersection types are distinguished. If the result of the analysis suggests allocating the analyzed intersection to the first intersection type, illustration elements predefined for the illustration of the schematic maneuvering view are loaded from the database and are subsequently displayed. If the result of the analysis by contrast suggests that the intersection to be illustrated corresponds to the second intersection type, the illustration elements required for the illustration are individually calculated. As a consequence, by way of this measure it can be attained that either a static and/or a dynamic illustration of the schematic maneuvering view is calculated and displayed as a function of the intersection type to be respectively illustrated. Hence, with the aid of the inventive method, the advantages of the known illustration methods for illustrating schematic maneuvering views are combined and the respective disadvantages of the individual method variants are thusly avoided.

According to the simplest embodiment of the inventive method, as a function of the result of the analysis of the position geometry, it is necessary to take the decision if either the static or else the dynamic illustration form for illustrating the schematic maneuvering view is to be selected. According to a preferred method variation, provision is equally made for the aspect that for specific intersection types, predefined illustration elements and individually calculated illustration elements are intermixed. In particular in more complex intersections, this measure makes it is possible that an intuitively well interpretable illustration of the intersection situation can be obtained by the schematic maneuvering view without excessive calculation time.

In the calculation and illustration of the schematic maneuvering view, the intermediate angles, with which the different road segments converging at a junction are illustrated, are of decisive significance. For the illustration of first intersection types which are to be illustrated by static illustration forms, fixedly preset angles are consequently stored in the database.

For the second intersection types, for which a dynamic or else a mixed static-dynamic illustration form is provided, the angles between the road segments converging at a junction are individually calculated as a function of the respective position geometry.

The creation of an exchange format as a result of the preceding analysis makes it possible to fully specify the intersection situation with only a small number of attributes. Hence, by indicating the intersection type and a small number of additional parameters for the correspondingly equipped display system it may already be unambiguously defined how an intersection situation can be illustrated.

By means of the compact illustration in an exchange format, it is equally possible to transfer the information about schematic maneuvering views not only within a device but also via wire-bound or wireless interfaces to separately operating illustration systems, for instance to a multi-function display in a vehicle.

The coding type of the exchange format is basically optional. As a function of the bandwidth of the communication interface with the graphical illustration system, binary formats or the XML format are suitable.

The use of an exchange format makes it possible that several graphical illustration styles are readily exchangeable and/or coexist in the device, since the respective graphical illustration system contains correspondingly predefined illustration elements in a separate database, which are activated by the data in the exchange format.

In order to simplify the analysis of the position geometry and the result to be derived therefrom for illustrating the schematic maneuvering view, it is particularly advantageous to create various intersection type classes which are each allocated certain illustration forms of the schematic maneuvering view.

Hence, it is for instance conceivable that different intersection type classes are provided for the intersection types “U-turn”, “traffic circle”, “bifurcation” and “other intersection type”.

The intersection type classes “U-turn” and “bifurcation” preferably should be allocated predefined illustration elements, since U-turn turning maneuvers and turning maneuvers at road bifurcations can only be displayed by such predefined illustration elements in an intuitively comprehensible fashion. For traffic circles, the intersection type class “traffic circle” should be created, wherein in determining such a traffic circle the illustration should preferably be performed by intermixing statically and dynamically calculated illustration elements.

For all intersection types which cannot be allocated to one of the three intersection type classes, the intersection type class “other intersection type” should be created. For said “other intersection types” the schematic maneuvering view should in each instance be individually calculated.

Different aspects of the inventive method are schematically illustrated in the drawings and are specified in the following by way of example.

In the drawings:

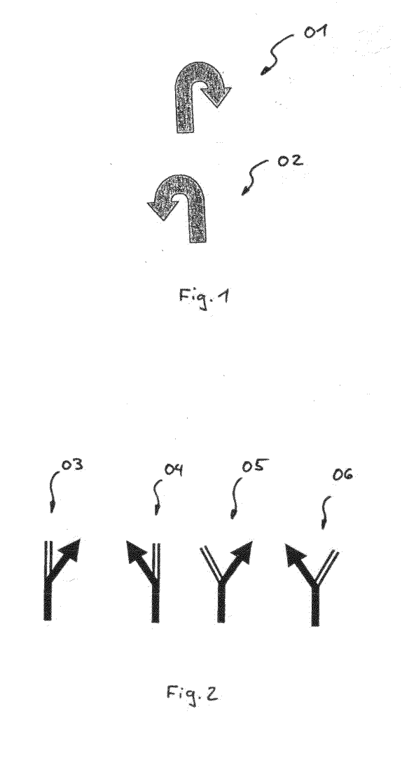

FIG. 1 shows static illustration elements for a first intersection type class;

FIG. 2 shows static illustration elements for a second intersection type class;

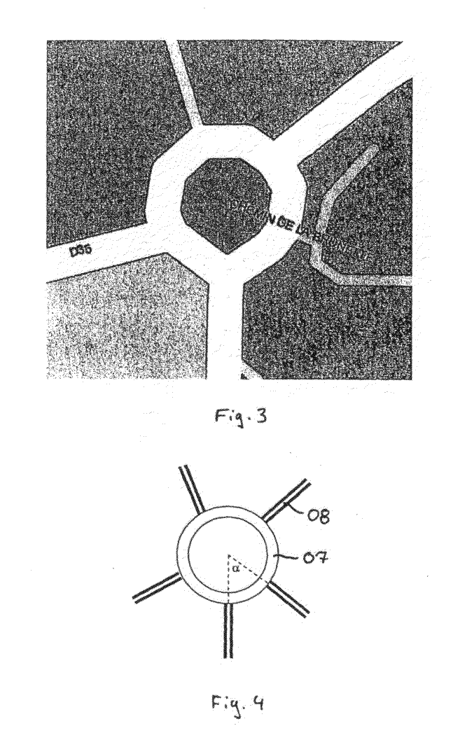

FIG. 3 shows a real road situation with a traffic circle;

FIG. 4 shows the schematic maneuvering view of the intersection according to FIG. 3;

FIG. 5 shows a real road intersection situation with another intersection type;

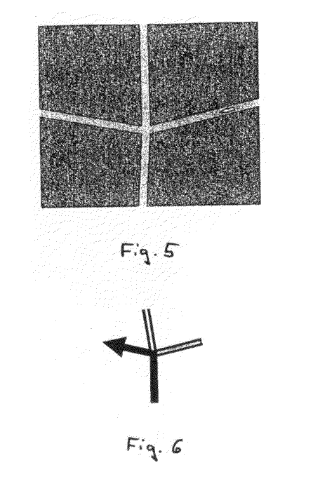

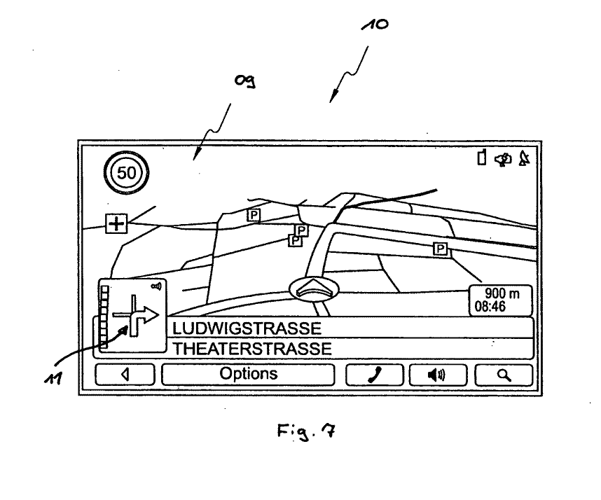

FIG. 6 shows the schematic maneuvering view of the intersection according to FIG. 5;

FIG. 7 shows the touch-screen of a navigation device with the display of a schematic maneuvering view.

If a turning maneuver with a “U-turn” is supposed to be displayed in a navigation system in a schematic maneuvering view, the static illustration elements 01 and 02 illustrated in FIG. 1 are utilized. This means that, regardless of the real angles of the road segments at the maneuver to be illustrated, either the illustration element 01 or the illustration element 02 is loaded from a database and is displayed at the display device. Whether the illustration element 01 or the illustration element 02 is utilized exclusively depends on the aspect of whether the relevant country adheres to left-hand traffic or right-hand traffic rules. The illustration element 01 serves for illustrating U-turn turning maneuvers in case of left-hand traffic, whereas the illustration element 02 serves for illustrating U-turn turning maneuvers in case of right-hand traffic. In the exchange format, in case of the present example, the schematic maneuvering view to be illustrated would already be sufficiently specified by the indication of intersection type=1=>U-turn and the additional parameter direction=0=>right-hand traffic or 1=>left-hand traffic.

FIG. 2 shows four static illustration elements 03 to 06 serving for the illustration of road bifurcations and being stored in a database in a predefined fashion. As a function of the analysis of the position geometry of the next maneuver at a road bifurcation, one of the illustration elements 03 to 06 can be loaded from the database. Here, the following bifurcations types can be distinguished: places which are specified as constituting bifurcations by the makers of digital maps, i.e. that all of the roads emerging from the intersection are of equal priority; places where the comparison of angles of the emerging roads suggests that they are optically similar to a bifurcation, and exit situations on freeways and roads constructed in the type of freeways. The illustration elements 03 and 04 in this context are utilized in exit situations, whereas the illustration elements 05 and 06 are utilized for real road bifurcations.

FIGS. 3 and 4 show the impact of the inventive method on the illustration of a traffic circle. In this context FIG. 3 shows a real road situation with a traffic circle featuring five roads which converge into the traffic circle. FIG. 4 shows the traffic circle in a schematic maneuvering view. For the illustration of the traffic circle, the fixedly predefined circular symbol 07 is loaded from the database and the roads emerging from the traffic circle in a radial fashion are indicated by road symbols 08. The respective intermediate angles α between the roads emerging from the traffic circle are determined by suitable calculation methods and are indicated in the schematic maneuvering view. In this respect, the illustration of the traffic circle in the schematic maneuvering view according to FIG. 4 constitutes a mixture of fixedly predefined illustration elements which are loaded from the database and of individually calculated illustration elements.

FIG. 5 and FIG. 6 show the impact of the inventive method on the illustration of another intersection type. In this context FIG. 5 shows in a schematized manner the real intersection situation with four road segments crossing one another at a junction. Here, one of the roads is marked as a one-way road by an arrow indicating the direction of travel.

FIG. 6 shows the schematic maneuvering view of the intersection situation shown in FIG. 5. Here, the intermediate angles between the individual roads are individually calculated and correspond precisely to the real angles, wherein the road marked as one-way road is marked in a particularly striking manner.

FIG. 7 illustrates the screen 09 of a navigation device 10, which can be designed for instance as a touch-screen. In the lower left-hand corner of the screen 09, a schematic maneuvering view 11 is superimposed which is composed of several illustration elements in a combinatorial fashion.

1. A method for operating a navigation system, the method comprising operating the navigation system to perform the following method steps of:
a) calculating a route from a starting position to a destination, wherein the route is composed of a succession of road segments and junctions between the road segments, the route being selected with the aid of a route calculation process from a database in which a geographical territory is specified by road segments and junctions;
b) calculating at least one maneuvering instruction which contains instructions for the user to follow the route at an intersection starting from the current position; and
c) calculating and displaying a schematic maneuvering view at a display device, wherein the schematic maneuvering view graphically illustrates the maneuvering instruction at an intersection in a schematized manner, wherein in the calculation of the schematic maneuvering view, the position geometry of the road segments and junctions associated with the intersection is analyzed, wherein for the illustration of first intersection types, predefined illustration elements are stored in a database and for the illustration of second intersection types, illustration elements (a) that are individually dependent on the position geometry can be calculated in a calculation unit, and wherein for calculating and displaying the schematic maneuvering view, predefined illustration elements are loaded from the database as a function of the result of the analysis and/or illustration elements (a) that are individually dependent on the position geometry are calculated in the calculation unit.

2. The method according to claim 1, in which for calculating and displaying the schematic maneuvering view, predefined illustration elements loaded from the database as a function of the result of the analysis and illustration elements calculated in the calculation unit as a function of the position geometry are intermixed.

3. The method according to claim 1, in which in the predefined illustration elements stored in relation to the first intersection types, the angles between the road segments converging at a junction are fixedly preset.

4. The method according to claim 1, in which for the second intersection types, angles between the road segments converging at a junction are individually calculated in the calculation unit as a function of the position geometry.

5. The method according to claim 1, in which subsequent to the analysis of the position geometry of the road segments and junctions associated with the intersection, the data necessary for calculating and displaying the schematic maneuvering view are converted into a predefined data exchange format and are passed on.

6. The method according to claim 1, in which in the analysis of the position geometry of the road segments and junctions associated with the intersection, different intersection type classes are distinguished, wherein as a function of the determined intersection type, predefined illustration elements or calculated illustration elements or mixtures of predefined illustration elements and of calculated illustration elements are displayed in accordance with a fixed presetting for illustration of the intersection in the schematic maneuvering view.

7. The method according to claim 6, in which “U-turn”, “traffic circle”, “bifurcation” or “other intersection type” are distinguished in terms of intersection types.

8. The method according to claim 7, in which for the intersection type class “U-turn”, predefined illustration elements are utilized.

9. The method according to claim 7, in which for the intersection type class “bifurcation”, predefined illustration elements are utilized.

10. The method according to claim 7, in which for the intersection type class “traffic circle”, a mixture of predefined illustration elements and calculated illustration elements is utilized.

11. The method according to claim 7, in which for the intersection type class “other intersection type” calculated illustration elements are utilized.
